(19) United States
(12) Patent Application Publication
(10) Pub. No.: US 2026/0264696 A1
(43) Pub. Date: Sep. 10, 2026

(54) METHOD FOR DETERMINING THE POSITION OF A MOTOR VEHICLE, DRIVING SYSTEM, AND MOTOR VEHICLE

(71) Applicant: Continental Autonomous Mobility Germany GmbH, Ingolstadt (DE)

(72) Inventor: Julien Seitz, Darmstadt (DE)

(73) Assignee: Continental Autonomous Mobility Germany GmbH, Ingolstadt (DE)

(21) Appl. No.: 18/728,317

(22) PCT Filed: Jan. 9, 2023
(86) PCT No.: PCT/DE2023/200005

§ 371 Date: May 21, 2026

(30) Foreign Application Priority Data
Jan. 14, 2022 (DE) 10 2022 200 349.7

(51) Int. Cl. B60W 40/12; B60W 40/04; B60W 60/00

(52) U.S. Cl. CPC B60W 40/12; B60W 40/04; B60W 60/001; B60W 2420/403; B60W 2420/408; B60W 2520/00

(57) ABSTRACT

The invention relates to a method for determining the position of a motor vehicle (1) comprising a driving system (2) which comprises at least one surroundings sensor system (3) and a filter system. Sensor-generated data is provided by the surroundings sensor system (3), and at least one object (9) is detected in the sensor-generated data. The at least one detected object (9) is used to generate a monitoring model which is then compared with a map of the surroundings, a comparison result being obtained therefrom. Furthermore, the presence of at least one special situation is checked. If no special situation is present, an estimated position (6) of the motor vehicle (1) is updated using the filter system on the basis of the comparison result. If a special situation is present, a weighting parameter is determined in order to modify the influence of the comparison result on the process of estimating the position, and the estimated position (6) of the motor vehicle (1) is updated using the filter system on the basis of the comparison result while applying the weighting parameter. The invention additionally relates to a driving system (2) which is designed to carry out the aforementioned method and to a motor vehicle (1) comprising such a driving system (2).

### FIELD OF THE INVENTION

The invention relates to a method for determining the position of a motor vehicle, to a driving system which is designed to carry out such a method and to a motor vehicle comprising such a driving system.

### BACKGROUND

One of the tasks of a driving system, in particular a driver assistance system or an autonomous driving system, in a motor vehicle is to determine the motor vehicle's ego-position in the surroundings as accurately as possible. Such a position determination can be carried out via satellite-based navigation systems, for example GPS. However, problems can arise during the position determination when there is no contact between the driving system and the satellites, for example, between high buildings or in a tunnel, or when the satellite signal is disturbed by electromagnetic fields in the stratosphere or ionosphere. In such cases and in order to verify the satellite-based position determination or as an alternative to the satellite-based position determination, the position is determined using surroundings sensors, in particular cameras, recognized objects and a map of the surroundings, in which a plurality of objects is recorded. The determining of the ego-position is carried out by comparing the positions of the detected objects and the information from the map of the surroundings.

Various problems can arise during this. On the one hand, at low vehicle speeds, one and the same object which the vehicle is currently passing is recognized again and again and used to determine the position. That is to say that the determination of the position depends very much on this one object. If, however, the object was not correctly detected, the distance from the object was not correctly estimated or if the object is incorrectly recorded in the map of the surroundings, then this results in an incorrectly determined position with-due to the large number of recognitions carried out-a supposedly high degree of accuracy. That is to say that the one error which was made in the case of the named object becomes a systematic error due to the frequent repetitions, which systematic error is self-confirmed with every update which is made with the named object. In order to counteract this problem, the updates of the estimated position are in part deactivated below a determined speed, wherein a hard switching over then takes place at this limit speed and at low speeds no position determination at all is carried out any more via recognized objects. One alternative is to only consider every nth sensor measurement at low speeds, wherein information is discarded in this case and a correction of the ego-position takes place at a lower frequency.

A further problem arises when, for example, on driving through a tunnel, there are no indications over a lengthy period of time and the determination of the position of the vehicle is only carried out via the inertial sensor technology. Then the uncertainty of the estimation of the ego-position increases. If an object is now observed, this has a great influence on the process of determining the ego-position, whereupon the uncertainty in the estimation of the ego-position quickly decreases in size. If, however, the object was not correctly detected in this case, the distance from the object was not correctly estimated or the object is incorrectly recorded in the map of the surroundings, then the incorrect position of the vehicle is estimated. Such an incorrect estimation can only be corrected later with difficulty by correct object observations. Smoothing filters which smooth out discontinuities are known as a solution to this problem, but they also mean additional complexity and additional computing outlay. Alternatively, the influence of the environment observations is generally reduced, as a result of which the position determination is admittedly slower overall.

### SUMMARY

It is the object of the invention to provide a method for determining the position of a motor vehicle, which eliminates the aforementioned problems. It is additionally the object of the invention to provide a driving system and a motor vehicle which eliminate the aforementioned problems. These objects are achieved by the subject-matter of the independent claims. Further developments of the invention are set out by the subclaims and the following description.

One aspect of the invention relates to a method for determining the position of a motor vehicle. The motor vehicle is in particular a motor vehicle driving on a road, for example a car, a motorcycle or a truck, but the method can also be utilized in aircraft and watercraft.

The motor vehicle comprises a driving system comprising at least one surroundings sensor system and a filter system. The surroundings sensor system comprises sensors which provide data from which objects in the surroundings of the motor vehicle can be detected. The filter system is a part of a computer system of the driving system. The filter system can be designed as a separate computing unit or can be an application on a computing unit. The filter system is set up to update an estimated position of the motor vehicle on the basis of new inputs.

In the case of the method, sensor-generated data is provided by the surroundings sensor system. Said sensor-generated data is then evaluated by a further part of the computer system, and at least one object is detected in the sensor-generated data. A direction, a distance, a type, a size and/or an orientation of the object is/are detected.

The at least one detected object is then used, likewise, by a part of the computer system to generate a monitoring model. The monitoring model comprises the locations of the individual objects, in particular the direction and/or distance thereof.

The monitoring model is then compared with a map of the surroundings and a comparison result is obtained herefrom. In the map of the surroundings, as many objects as possible are recorded as accurately as possible in the surroundings of the motor vehicle. In addition to the location of the objects, an object type, a size of the object and/or further object parameters are preferably also contained in the map of the surroundings. The comparison result indicates the accuracy of the match between the monitoring model and the map of the surroundings and serves as a measure of a probability that the motor vehicle has a determined position on the basis of the detected object or objects.

The presence of at least one special situation is additionally checked. If no special situation is present, the estimated position of the motor vehicle is updated using the filter system on the basis of the comparison result. Here, the estimated position can comprise a position, but usually comprises a plurality of possible positions together with probabilities for each of these positions. Here, the details differ, in particular as a function of the filter system used, but are known to the person skilled in the art.

If a special situation is present, a weighting parameter is initially determined in order to modify the influence of the comparison result on the process of estimating the position. This weighting parameter is dependent on the special situation. The estimated position is updated using the filter system on the basis of the comparison result while applying the weighting parameter.

In special situations, the process of updating the estimated position is influenced by the application of the weighting parameter. In particular, in special situations, this ensures that the updating of the estimated position does not lead to an incorrect position estimation, in particular, when one or more objects are systematically not correctly estimated, i.e., not correctly detected, the distance from the objects is not correctly estimated or the objects are incorrectly recorded in the map of the surroundings.

In some embodiments, the driving system is a driver assistance system which comprises, for example, a brake assistant and/or an adaptive cruise control system. Alternatively or additionally, the driving system is an autonomous driving system. An accurate determination of the position of the motor vehicle and also of the uncertainty of this position determination is advantageous or even necessary and is improved by the method.

In some embodiments, the surroundings sensor system comprises at least one camera, a stereo camera, a radar and/or a lidar. Objects and the type and size thereof can be easily detected via computer-aided vision with cameras. The direction of the objects is obtained directly, while a distance of the objects can be obtained, for example, via a change in the object during the movement of the motor vehicle or via a determination using a known size of the object. A stereo camera can be used to additionally determine the distance of the object directly. The direction and the distance of the objects are determined particularly well with the radar and/or lidar, while the type of object can often only be approximately inferred. The measurement results of multiple surroundings sensors are preferably combined in order to obtain data about an object which is as accurate as possible and to create a monitoring model which is as accurate as possible therefrom.

In some embodiments, the filter system comprises a state estimator. A state estimator estimates the state, in this case the position, of the motor vehicle and contains information about the probability of these state estimates. A plurality of such state estimators is known, for example a Kalman filter and/or a particle filter. The details of the updating of the estimated position and the application of the weighting parameter depend on the respective state estimator. In the case of each state estimator, however, the application of the weighting parameter brings about an improved determination of the position in special situations, in particular when objects are systematically not correctly estimated, i.e., not correctly detected, the distance from the objects is not correctly estimated or the objects are incorrectly recorded in the map of the surroundings.

In some embodiments, the special situation is a speed of the motor vehicle below a predetermined speed value. Such a predetermined speed value can be, for example, between 2 km/h and 50 km/h, in particular between 5 km/h and 20 km/h, very particularly 10 km/h. If the motor vehicle slowly passes an object, then numerous sensor measurements are taken of this one object and these numerous sensor measurements are used to update the estimated position. If the object is now not correctly detected, the distance from the object is not correctly estimated or the object is incorrectly recorded in the map of the surroundings, then an incorrect position of the motor vehicle is estimated with a supposedly high probability due to the many updates on the basis of this object.

The fact that the weighting parameter with which the individual updates are weighted less is now used below the predetermined speed value means that an improved estimation of the position is achieved in this special situation.

In some embodiments, the weighting parameter is a monotonously nondecreasing first function of the speed of the motor vehicle. That is to say that the slower the motor vehicle, the lower the individual measurements are weighted.

In some embodiments, the first function assumes the value 1 on reaching and/or exceeding the predetermined speed value. This means that when the speed is equal to and/or greater than the predetermined speed value, the measurements are normally weighted as in the case in which no special situation is present. In a predefined speed range, the first function can be proportional to the speed of the motor vehicle. In this speed range, the measurements of an object are then included in the estimation of the position to the same degree, independently of the speed: at low speeds there is a larger number of measurements, however with a lower weighting, and at higher speeds there are fewer measurements, however with a higher weighting. Thus, the estimation of an incorrect position with a supposedly high probability is counteracted.

In some embodiments, the special situation is an uncertainty of the estimated position of the motor vehicle above a predetermined position uncertainty value. For example, the standard deviation can serve as a measure of the uncertainty. The predetermined position uncertainty value can be between 0.2 m and 10 m, in particular between 1 m and 5 m, very particularly 2 m. Such a high degree of position uncertainty can result, for example, when the motor vehicle drives for a lengthy period of time without objects to be detected and without reception of the satellite-based navigation system, for example, when the motor vehicle drives through a tunnel. The fact that there is a high degree of position uncertainty means that the position uncertainty is quickly reduced by the subsequent first measurement results. However, if an object is not correctly detected during these measurements, the distance from an object is not correctly estimated, or the object is incorrectly recorded in the map of the surroundings, it can happen that the position estimate quickly converges with regard to a faulty hypothesis and the position uncertainty is quickly reduced.

The fact that the weighting parameter with which the individual updates are weighted less is now used on exceeding the predetermined position uncertainty value means that an improved estimate of the position is achieved in this special situation.

In some embodiments, the weighting parameter is a monotonically decreasing second function of the uncertainty of the position of the motor vehicle. That is to say that the greater the uncertainty of the estimated position of the motor vehicle, the lower the individual measurements are weighted.

In some embodiments, the second function assumes the value 1 on reaching and/or falling short of the predetermined position uncertainty value. That means that when the uncertainty of the estimated position is equal to and/or less than the predetermined position uncertainty value, the measurements are normally weighted as in the case in which no special situation is present. In a predefined range of the uncertainty of the estimated position, the second function can depend linearly on the uncertainty of the estimated position. That is to say that in the event that the estimated position is very uncertain, the updating of the estimated position is only carried out with a lower weighting, so that the estimation of an incorrect position with a supposedly high probability is counteracted.

In some embodiments, if more than one special situation is present, the weighting parameters belonging to the corresponding special situations are combined. An example of this is when a motor vehicle drives slowly out of an underground parking garage: as a result of driving in the underground parking garage, the uncertainty in the estimated position is greater than the predetermined position uncertainty value and as a result of driving slowly, the speed is lower than the predetermined speed value. In this case, the weighting parameters can be combined in such a way that the product of the individual weighting parameters is formed. In the above example, the weighting of the individual measurements after exiting the underground parking garage is then very low, so that an estimation of an incorrect position with a supposedly high probability is avoided. However, the weighting parameters can also be combined in such a way that the minimum of the individual weighting parameters is used as a combined weighting parameter. This also counteracts an estimation of an incorrect position with a supposedly high probability, but the position determination is carried out more quickly in the case of the previous example.

One further aspect of the invention relates to a driving system. The driving system comprises at least one surroundings sensor system and a filter system. The driving system is additionally designed to execute the method according to the preceding description. That is to say that the driving system is designed in such a way that when special situations are present, an estimation of an incorrect position with a supposedly high probability is counteracted. Further advantages are set out by the preceding description.

In some embodiments, the driving system is a driver assistance system which comprises, for example, a braking assistant and/or an adaptive cruise control system. Alternatively or additionally, the driving system is an autonomous driving system. An accurate determination of the position of the motor vehicle and also of the uncertainty of this position determination is advantageous or even necessary and is improved by the driving system.

Yet another aspect of the invention relates to a motor vehicle comprising a driving system according to the preceding description. That is to say that the driving system of the motor vehicle is designed in such a way that, when special situations are present, an estimation of an incorrect position with a supposedly high probability is counteracted. Further advantages are set out in the preceding description.

For further clarification, the invention is described with reference to embodiments illustrated in the figures. These embodiments are understood to only be exemplary; they do not limit the invention.

### BRIEF DESCRIPTION OF THE FIGURES

FIG. 1 shows a schematic side view of an exemplary embodiment of a motor vehicle;

FIG. 2a shows an example of a temporal development of an estimated position;

FIG. 2b shows a further example of a temporal development of an estimated position;

FIG. 2c shows yet another example of a temporal development of an estimated position;

FIG. 3 shows a function of a weighting parameter;

FIG. 4a shows yet another example of a temporal development of an estimated position;

FIG. 4b shows yet another example of a temporal development of an estimated position; and

FIG. 5 shows a further function of a weighting parameter.

### DETAILED DESCRIPTION OF EMBODIMENTS

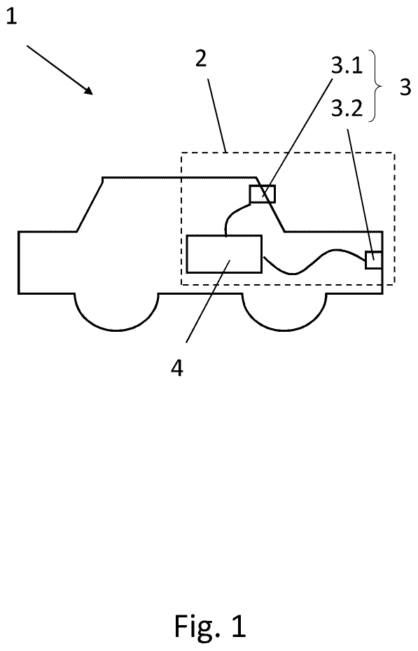

FIG. 1 shows a schematic side view of an exemplary embodiment of a motor vehicle 1. The motor vehicle 1 is depicted as a car in this exemplary embodiment. However, the present invention also relates to other road vehicles such as motorcycles or trucks, as well as aircraft and watercraft.

The motor vehicle 1 comprises a driving system 2. The driving system 2 can be a driver assistance system and/or an autonomous driving system. The driving system 2 comprises two sensors 3.1 and 3.2 which together form a surroundings sensor system 3. In alternative exemplary embodiments, the surroundings sensor system 3 can comprise only one sensor 3.1 or a plurality of sensors 3.1-3.x. In the present exemplary embodiment, the first sensor 3.1 is, for example, designed as a camera and the second sensor 3.2 is designed as a radar. Further sensors 3.x can be a stereo camera or a lidar, for example.

Sensor-generated data is provided using the surroundings sensor systems 3 and forwarded to a computer system 4 of the driving system 2. The computer system 4 can comprise one or more computing units. The sensor-generated data is analyzed by the computer system 4. Objects which were captured by the sensor-generated data are detected. From these objects, a monitoring model is generated which comprises the individual objects and the properties thereof such as the direction, distance, object type, size and/or orientation.

The monitoring model is then compared with a map of the surroundings which is stored in a memory of the driving system. A comparison result is obtained from this comparison, which quantifies the match between the monitoring model and the map of the surroundings.

The driving system additionally comprises a filter system. The filter system can be a separate computing unit of the computer system 4 or can run as an application on a computing unit of the computer system 4. The filter system has an estimated position which is initialized, for example, when the motor vehicle 1 is started. On the basis of the comparison result, the filter system then updates the estimated position of the motor vehicle 1. That is to say that the new estimated position is based on the previous estimated position, together with the comparison between the monitoring model and the map of the surroundings.

Various filter models are conceivable, in particular state estimators such as a Kalman filter and/or a particle filter. The method is described below with reference to a particle filter. The person skilled in the art is familiar with the transfer to other filter models:

The particle filter describes a plurality of particles i, wherein the particle i has the probability

$${w}_{t}^{( i )}$$

at a time t. A vehicle position hypothesis

$${x}_{t}^{( i )}$$

is assigned to the particle i. The probability

$${w}_{t}^{( i )}$$

is then updated with the results of the new sensor measurements according to the following formula:

$${w}_{t}^{( i )} ∼ {w}_{t - 1}^{( i )} g ( {y}_{t} / {x}_{t}^{( i )} ) \cdot g ( {y}_{t} / {x}_{t}^{( i )} )$$

is produced from the comparison between the monitoring model and the map of the surroundings and is a measure of the probability that the position

$${x}_{t}^{( i )}$$

is compatible with the map of the surroundings on the basis of the sensor measurement results.

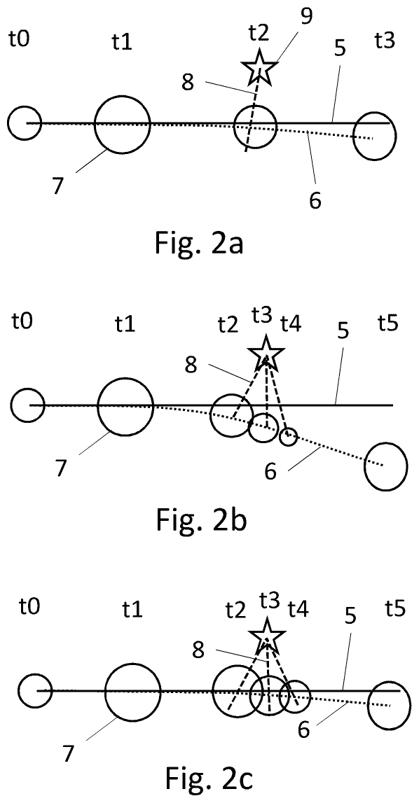

The updates of the estimated position can become problematic when one or more objects are systematically not estimated correctly, i.e., not detected correctly, the distance from the objects is not correctly estimated, or the objects are incorrectly recorded in the map of the surroundings. Such an example is shown in FIG. 2a. Here, the actual position 5 (continuous line), the estimated position 6 (dotted line) and the uncertainty 7 of the estimated position (circles) are depicted for various times t0, . . . , t3. At time t2, a sensor measurement 8 (dashed line) of an object 9 (star shape) is carried out, which is systematically not estimated correctly. This results in an estimated position 6 which deviates from the actual position 5, but is still compatible with the actual position 5 within the uncertainty 7.

The situation is different in the example in FIG. 2b. Here, the motor vehicle 1 slowly drives past the object 9 between the times t2 and t4 and carries out a sensor measurement 8 for each of these times, which is systematically not correctly estimated. Due to the multiplicity of measurements, the uncertainty 7 of the estimated position becomes smaller and, in the present example, becomes so small that the estimated position 6 no longer corresponds to the actual position 5 within the uncertainty 7.

In order to counteract this, a special situation was detected in FIG. 2c, namely that the motor vehicle 1 is driving slowly. A weighting parameter F was determined which decreases the influence of the individual measurement on the process of estimating the position. The probabilities

$${w}_{t}^{( i )}$$

are then updated as follows:

$${w}_{t}^{( i )} ∼ {w}_{t - 1}^{( i )} {g ( {y}_{t} / {x}_{t}^{( i )} )}^{F} .$$

The systematically incorrectly estimated sensor measurement is given a lower weight by the weighting parameter F and, consequently, the uncertainty 7 of the estimated position remains so great that the estimated position 6 matches the actual position 5 within the uncertainty 7.

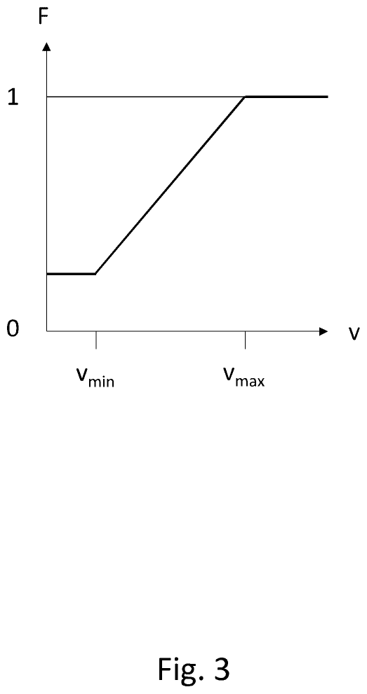

The weighting parameter F can, for example, be given as a function of the speed v of the motor vehicle 1 as depicted in FIG. 3. The weighting parameter Fis proportional to the speed v in a range between a lower speed value Vₘᵢₙ and a predetermined speed value Vₘₐₓ.

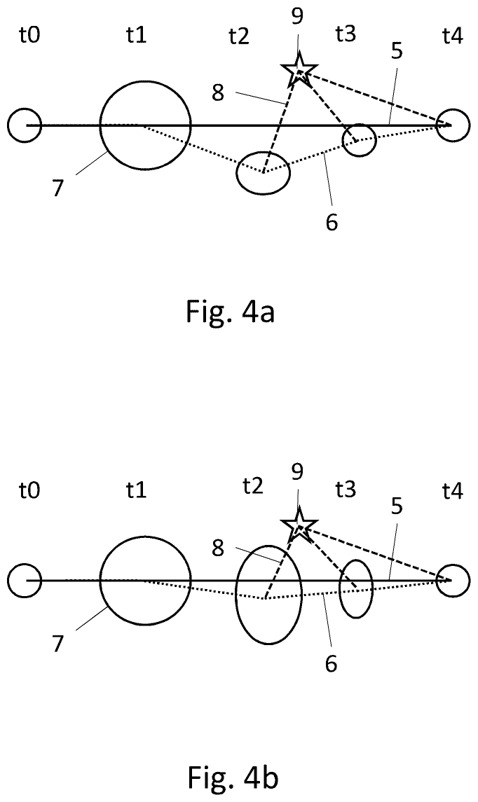

Another example is depicted in FIG. 4a. Here, the motor vehicle 1 drove in a tunnel from time t0 to t1, for example, so that the uncertainty 7 of the estimated position at time t1 is very large. If a systematically incorrectly estimated sensor measurement 8 of the object 9 is then carried out at time t2, the estimated position 6 collapses to an estimated position 6 which is further away from the actual position 5 than the uncertainty 7 which likewise collapsed. Only after multiple, now correct, sensor measurements 8 of the object 9 at times t3 and t4 does the estimated position 6 again match the actual position 5 within the uncertainty 7. However, it is also possible that the particle filter will no longer recover at all from this incorrect measurement.

In order to counteract this, a special situation was detected in FIG. 4b, namely an uncertainty 7 of the estimated position 6 above a predetermined position uncertainty value. A weighting parameter F was determined which decreases the influence of the following measurement on the process of estimating the position. The probabilities

$${w}_{t}^{( i )}$$

are then updated as before:

$${w}_{t}^{( i )} ∼ {w}_{t - 1}^{( i )} {g ( {y}_{t} / {x}_{t}^{( i )} )}^{F} .$$

The systematically incorrectly estimated sensor measurement is given a lower weight by the weighting parameter F and, consequently, the uncertainty 7 of the estimated position remains so great that the estimated position 6 matches the actual position 5 within the uncertainty 7.

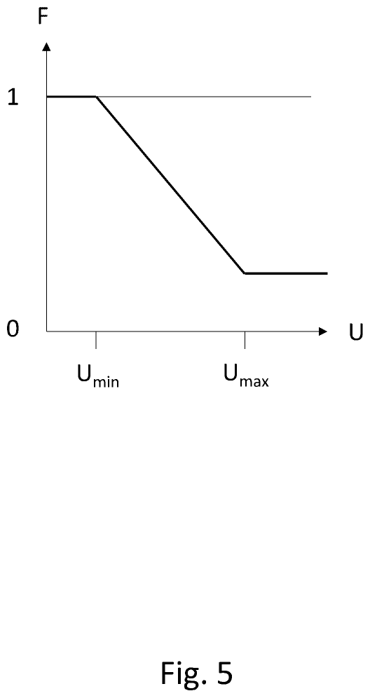

The weighting parameter F can be given, for example, as a function of the uncertainty U of the motor vehicle 1, as depicted in FIG. 5. The weighting parameter F runs linearly with the uncertainty U in a range between a predetermined position uncertainty value Uₘᵢₙ and an upper position uncertainty value Uₘₐₓ.

### LIST OF REFERENCE NUMERALS

1 Motor vehicle
2 Driving system
3 Surroundings sensor system
3.1 Camera
3.2 Radar
4 Computer system
5 Actual position
6 Estimated position
7 Uncertainty of the estimated position
8 Sensor measurement
9 Object

1. A method for determining the position of a motor vehicle, the method comprising a:
obtaining sensor-generated data provided by a sensor of the motor vehicle;
detecting an object based on the sensor-generated data;
generating a monitoring model based on the object;
comparing the monitoring model to a map of surroundings of the motor vehicle;
estimating a position of the motor vehicle based on a result of comparing the monitoring model to the map of the surroundings of the motor vehicle; and
applying a weighting parameter to the estimated position of the motor vehicle based on a speed of the motor vehicle to generate an updated estimated position of the motor vehicle.

2. The method according to claim 1, wherein the motor vehicle comprises a driver assistance system and/or an autonomous driving system configured to determine the position of the motor vehicle.

3. The method according to claim 1, wherein the sensor comprises at least one of a camera, a stereo camera, a radar and/or a lidar.

4. The method according to claim 1, wherein the estimating comprises a Kalman filter and/or a particle filter estimating the position of the motor vehicle.

5. The method according to claim 1, applying the weighting parameter comprises applying the weighting parameter based on a speed of the motor vehicle being below a predetermined speed value.

6. The method according to claim 5, wherein the weighting parameter is a monotonously nondecreasing first function of the speed of the motor vehicle.

7. The method according to claim 6, wherein the first function assumes the value 1 on reaching and/or exceeding the predetermined speed value and, at least in a predefined speed range, is proportional to the speed of the motor vehicle.

8. The method according to claim 1, wherein applying the weighting parameter comprises applying a first weighting parameter to the estimated position of the motor vehicle based on the speed of the motor vehicle and a second weighting parameter based on an uncertainty of the estimated position of the motor vehicle above a predetermined position uncertainty value to generate the updated estimated position of the motor vehicle.

9. The method according to claim 8, wherein the second weighting parameter is a monotonically decreasing second function of the uncertainty of the estimated position of the motor vehicle.

10. The method according to claim 9, wherein the second function assumes the value 1 on reaching and/or falling short of the predetermined position uncertainty value and at least in a predefined range of the uncertainty of the estimated position, depends linearly on the uncertainty of the estimated position.

11-14. (canceled)
